(19) United States
(12) Patent Application Publication
(10) Pub. No.: US 2009/0072454 A1
(43) Pub. Date: Mar. 19, 2009

(54) Air-Damped Mounting Bush

(75) Inventors: Arndt Graeve, Koblenz (DE); Eric Eisel, Ellenhausen (DE)

Correspondence Address: LERNER GREENBERG STEMER LLP, P O BOX 2480, HOLLYWOOD, FL, 33022-2480, US

(73) Assignee: TRELLEBORG AUTOMOTIVE TECHNICAL CENTRE GMBH, Hohr-Grenzhausen (DE)

(21) Appl. No.: 12/255,238

(22) Filed: Oct. 21, 2008

Related U.S. Application Data
(63) Continuation of application No. PCT/EP2007/053886, filed on Apr. 20, 2007.

(30) Foreign Application Priority Data
Apr. 21, 2006 (DE) 102006018621.4

(51) Int. Cl. F16F 13/14; F16F 5/00

(52) U.S. Cl. 267/121; 16/2.1

(57) ABSTRACT

A mounting bush contains an inner mount part supported by a resilient body made of an elastomeric material. The resilient body is mounted in an outer housing of a mount or on a chassis mounting pad. The resilient body defines at least two air-filled working chambers interconnected by at least one damping channel. The working chambers are low profile and contain a low linear excursion. A ratio of the pumping diameter to a linear excursion of 15 to 80 is provided.

### CROSS-REFERENCE TO RELATED APPLICATIONS

This is a continuing application, under 35 U.S.C. § 120, of copending international application PCT/EP2007/053886, filed Apr. 20, 2007, which designated the United States; this application also claims the priority, under 35 U.S.C. § 119, of German patent application DE 10 2006 018 621.4, filed Apr. 21, 2006; the prior applications are herewith incorporated by reference in their entireties.

### BACKGROUND OF THE INVENTION

### Field of the Invention

The invention relates to a mounting bush containing an inner mount part supported by an elastomeric resilient body mounted on an outer housing of the mount or on a chassis mounting pad.

Such mounting bushes are employed especially on automotive chassis structures or also on assembly pendulum mounts. Known for this purpose are conventional rubber to metal bushes in which a resilient body is vulcanized in place between the inner mount part and an outer housing. Known in addition are also hydraulic damping mounting bushes in which two fluid-filled working chambers are interconnected by a damping channel. Such hydraulic damping bushes excel by good damping, however they are noisy in the same direction in space. The hydraulic components of which hike the component costs and make for added complications in development. Another possibility often made use of is to use high-damping rubber composites. Here, however, because of their dynamic properties in all directions in space such composites prove to be poor insulators.

### SUMMARY OF THE INVENTION

It is accordingly an object of the invention to provide an air-damped mounting bush that overcomes the above-mentioned disadvantages of the prior art devices of this general type, which features a high damping performance at low component costs.

With the foregoing and other objects in view there is provided, in accordance with the invention, a mounting bush. The mounting bush contains an outer housing, a resilient body made of an elastomeric material and mounted in the outer housing, and an inner mount part supported by the resilient body. The resilient body and the outer housing define at least two air-filled working chambers interconnected by at least one damping channel. The working chambers are configured as low profile and contain a low linear excursion. A ratio of a pumping diameter to the linear excursion is 15 to 80.

In the mounting bush in accordance with the invention the resilient body defines at least two air-filled working chambers interconnected by at least one damping channel or which are each connected to the ambience by an overflow port. In this arrangement the working chambers are configured as low profile and feature a low linear excursion, the ratio of a pumping diameter to the linear excursion amounting to 15 to 80.

In keeping with the present application, the pumping diameter is understood to be a pneumatic characteristic. The pumping diameter corresponds to the hydraulic diameter of the hydraulic components. A displacement of the core by a linear excursion X dispels a volume V of air from the corresponding working chamber. Dividing the dispelled volume V by the linear excursion X needed for this purpose results in an active surface in the present invention. Depending on the configuration of the mounting bush the active surface can take on various shapes, for example, it can be rectangular or round. Transforming the surface content of the active surface into a (fictive) circular surface results in the pumping diameter as defined. The ratio of the pumping diameter to the linear excursion X is thus dimensionless.

The damping effect of the mounting bush in accordance with the invention is achieved by the air being displaced between the two working chambers or into the ambience. To maximize the damping work (phase angle) the mounting bush in accordance with the invention features a large pumping diameter (active surface) as well as a low linear excursion. This results in the working chamber being compressed near totally in the range of the linear excursion. The further progression profile is tweaked outside of the working chamber. Since the working medium is air existing in both the working chambers and in the ambience the demands on preventing leakage as compared to hydraulic mounting bushes are substantially less. In all, the mounting bush in accordance with the invention achieves a damping effect which is higher and more specially adapted than on conventional mounting bushes having highly damping composites. On top of this, the mounting bush in accordance with the invention excels by relatively low production costs.

Preferably the working chambers feature a ratio of pumping diameter to the linear excursion of 20 to 40.

The diameter of the damping channel is preferably 0.5 mm to 1.5 mm, preferably 1 mm.

In one advantageous embodiment the resilient body is vulcanized to the inner mounting part.

In another advantageous embodiment a clip is slip-mounted on the resilient body to bias the resilient body in the region of the working chamber. Hereby the useful life of the mounting bush is increased.

Other features which are considered as characteristic for the invention are set forth in the appended claims.

Although the invention is illustrated and described herein as embodied in an air-damped mounting bush, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 is a diagrammatic, vertical sectional view through a first embodiment of a mounting bush in accordance with the invention;

FIG. 2 is a diagrammatic, sectional view taken along the line II-II shown in FIG. 1;

FIG. 3 is a diagrammatic, sectional view taken along the line III-III shown in FIG. 1;

FIG. 4 is a diagrammatic, longitudinal sectional view through a second mounting bush in accordance with the invention; and

FIG. 5 is a diagrammatic, vertical sectional view through a third embodiment in accordance with the invention.

### DETAILED DESCRIPTION OF THE INVENTION

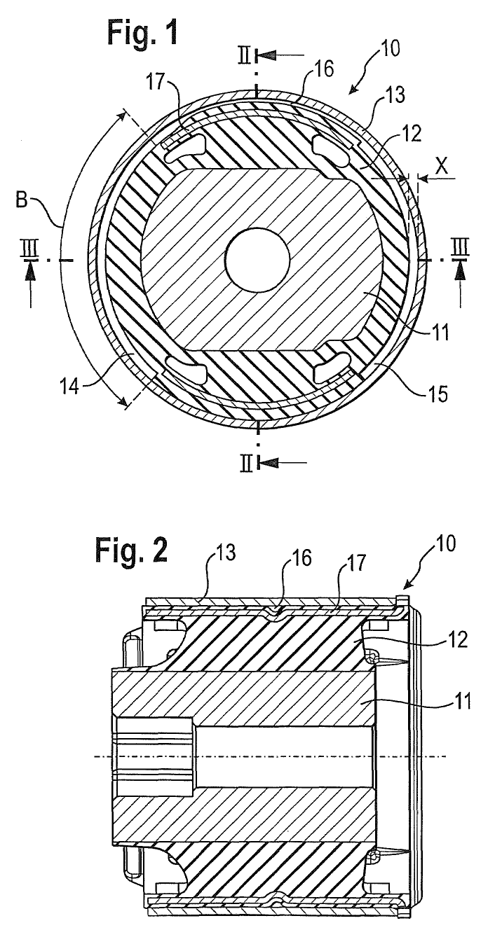

Referring now to the figures of the drawing in detail and first, particularly, to FIGS. 1-3 thereof, there is illustrated in various views a mounting bush 10 containing an inner mount part 11 made of metal. The inner mount part 11 is supported by an elastomeric resilient body 12 mounted in an outer housing 13. It may also be provided for, however, that the mounting bush 10 is directly inserted into a chassis mounting pad which then functions as an outer housing 13.

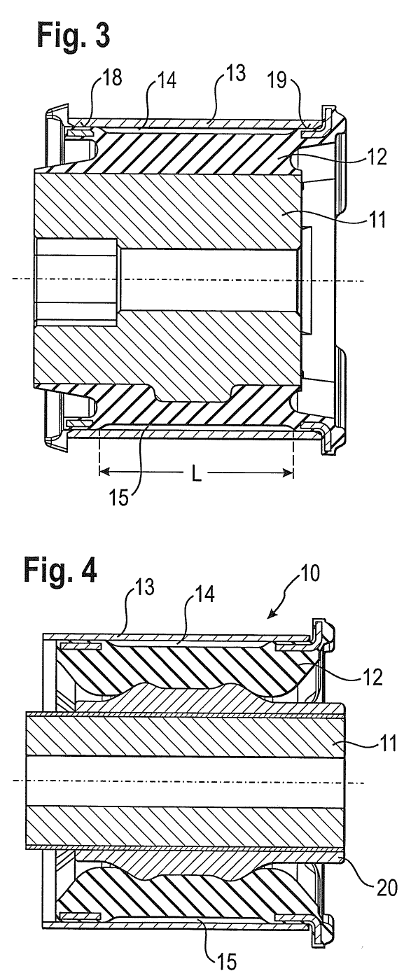

The resilient body 12 defines with the outer housing 13 or the chassis mounting pad two working chambers 14, 15, each filled with air and interconnected by a damping channel 16. As evident from the FIGS. 1-3 the working chambers 14, feature a relatively large pumping diameter. The working chambers 14, 15 are furthermore characterized by a minor linear excursion (spacing distance) X in the radial direction. As already explained, a pumping diameter materializes from the so-called active or pumping surface established by the displacement volume of the working chambers and the linear excursion X. The value for the active surface is established as a fictive circular surface from which the pumping diameter is established. In the present example aspect the active surface materializes from a width B as shown in FIG. 1 and a length L as shown in FIG. 3 of the working chambers 14, 15. In the example aspect as shown the ratio of the pumping diameter to the linear excursion X is approximately 25.

Referring now to FIG. 2 there is illustrated how the resilient body 12 is vulcanized in a cage 17. FIG. 2 also shows how the damping channel 16 is disposed roughly in the middle of the bush and has a very small diameter of approximately 1 mm.

Referring now to FIG. 3 there is illustrated how the working chambers 14, 15 substantially cover the full width of the resilient body 12. The working chambers 14, 15 are sealed by sealing surfaces 18, 19 provided at the resilient body 12 in cooperation with the outer housing 13. The sealing surfaces 18, 19 can be maintained relatively small since air exists in both the working chambers 14, 15 and in the ambience.

Referring now to FIG. 4 there is illustrated a further example aspect of the mounting bush 10 in accordance with the invention, the description of which uses like reference numerals for like parts or like in function as before. Here too the mounting bush 10 as shown contains the inner mount part 11 mounted by the resilient body 12 at the outer housing 13. To bias the resilient body 12 in the region of the working chambers 14, 15, a clip 20 is provided slip-mounted on the inner mount part 11. The useful life of the mounting bush 10 is increased hereby.

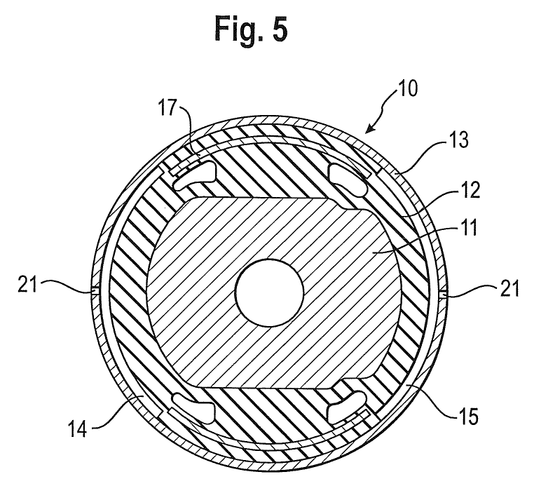

Referring now to FIG. 5 there is illustrated another example aspect of the mounting bush 10 in accordance with the invention, here again like parts or like in function being identified by like reference numerals. The mounting bush 10 contains two working chambers 14, 15 not interconnected in this case by a damping channel 16. Each working chamber 14, 15 contains an overflow port 21 machined in the outer housing 13 producing the connection to the ambience.

The mounting bush 10 put to use particularly in automotive chassis fixtures is characterized by being air damped. The air in the working chambers 14, is displaced between the two chambers 14, 15. Because of the large pumping diameter in conjunction with the low linear excursion X a high damping potential is achieved. Under maximum load the working chambers 14, 15 are compressed near totally. The progression profile is tweaked outside of the working chambers 14, 15. Thus, a high damping effect for very precise adaptation can be achieved.

1. A mounting bush, comprising:
an outer housing;
a resilient body made of an elastomeric material and mounted in said outer housing; and
an inner mount part supported by said resilient body, said resilient body and said outer housing defining at least two air-filled working chambers interconnected by at least one damping channel, said working chambers being configured as low profile and contain a low linear excursion, and a ratio of a pumping diameter to said linear excursion is 15 to 80.

2. The mounting bush according to claim 1, wherein said working chambers contain a ratio of the pumping diameter to the linear excursion of 20 to 40.

3. The mounting bush according to claim 1, wherein said damping channel has a diameter of 0.5 mm to 1.5 mm.

4. The mounting bush according to claim 1, wherein said resilient body is vulcanized to said inner mount part.

5. The mounting bush according to claim 1, further comprising a clip, said resilient body is biased by means of said clip slipped onto said inner mount part.

6. The mounting bush according to claim 1, wherein the mounting bush is pressed directly into said outer housing being a chassis mounting pad.

7. The mounting bush according to claim 1, wherein said damping channel has a diameter of 1 mm.

8. A mounting bush, comprising:
an outer housing having overflow ports formed therein;
a resilient body made of an elastomeric material and mounted in said outer housing; and
an inner mount part supported by said resilient body, said resilient body and said outer housing defining at least two air-filled working chambers each connected to ambience by one of said overflow ports, said working chambers are configured as low profile and contain a low linear excursion, and a ratio of pumping diameter to the linear excursion is 15 to 80.

9. The mounting bush according to claim 8, wherein said working chambers contain a ratio of the pumping diameter to the linear excursion of 20 to 40.

10. The mounting bush according to claim 8, wherein said resilient body is vulcanized to said inner mount part.

11. The mounting bush according to claim 8, further comprising a clip, said resilient body is biased by means of said clip slipped onto said inner mount part.

12. The mounting bush according to claim 8, wherein the mounting bush is pressed directly into said outer housing being a chassis mounting pad.
